(19) United States
(12) Patent Application Publication
(10) Pub. No.: US 2019/0339716 A1
(43) Pub. Date: Nov. 7, 2019

(54) METHOD AND SYSTEM FOR PROVIDING AN AT LEAST PARTIALLY AUTOMATIC GUIDANCE OF A FOLLOWING TRANSPORTATION VEHICLE

(71) Applicant: VOLKSWAGEN AKTIENGESELLSCHAFT, Wolfsburg (DE)

(72) Inventor: Stephan KOPISCHKE, Wolfsburg (DE)

(21) Appl. No.: 16/476,623

(22) PCT Filed: Dec. 19, 2017
(86) PCT No.: PCT/EP2017/083676

§ 371 Date: Jul. 9, 2019

(30) Foreign Application Priority Data
Jan. 9, 2017 (DE) 10 2017 200 168.2

(51) Int. Cl. G05D 1/02; B60W 50/14; G08G 1/00; G06Q 20/10

(52) U.S. Cl. CPC G05D 1/0295; B60W 50/14; G08G 1/22; G06Q 20/10; B60W 2550/408; B60W 30/165; B60W 2550/402; B60W 2050/146; G05D 2201/0213; B60W 2750/40; B60W 2540/04

(57) ABSTRACT

A method for providing an at least partially automatic guidance of a following transportation vehicle. Availability data of at least one lead transportation vehicle and request data of the following transportation vehicle are acquired. Based on the availability data and the request data, offer data are generated via the lead transportation vehicle and transmitted to the following transportation vehicle. Based on the offer data, an offer output is generated and outputted. A user input is captured and acceptance data is generated based on the user input. Tracking data are generated and transmitted to the following transportation vehicle, and the following transportation vehicle is guided at least in part automatically behind the lead transportation vehicle based on the tracking data. A system for providing an at least partially automatic guidance of a following transportation vehicle having a detection unit, an offer unit, a computing unit, and an output unit.

### PRIORITY CLAIM

This patent application is a U.S. National Phase of International Patent Application No. PCT/EP2017/083676, filed 19 Dec. 2017, which claims priority to German Patent Application No. 10 2017 200 168.2, filed 9 Jan. 2017, the disclosures of which are incorporated herein by reference in their entireties.

### SUMMARY

Illustrative embodiments relate to a method and to a system for providing at least partially automatic guidance of a following transportation vehicle.

### BRIEF DESCRIPTION OF THE DRAWINGS

Disclosed embodiments will now be explained with reference to the drawings, in which:

FIG. 1 shows a traffic situation in which the disclosed method can be executed;

FIG. 2 shows a network between transportation vehicles and a switching device for the disclosed method; and

FIG. 3 shows an exemplary embodiment of the disclosed system.

### DETAILED DESCRIPTION

Wide ranging automation of transportation vehicles is being pursued with the aim of increasing efficiency and safety in traffic and in logistics, in particular, in transporting goods, but also in transporting passengers. For this purpose, technologies are already known which relieve the burden on the driver by automatic interventions at various levels in the control of a transportation vehicle or carry out individual driving maneuvers completely automatically. This stems as far as remote control or automatic travel along a route by a transportation vehicle.

The higher the degree of automatic interventions in the control here, the greater the requirements made of the equipment of the transportation vehicle which is controlled in such a way. For example, a multiplicity of redundant sensors are necessary for reliable, comprehensive observation of the surroundings, and the processing of the data which occur in this context requires high computing capacity on the part of the transportation vehicle. For this reason, a fully automatic control of transportation vehicles can be implemented only with considerable technical and financial expenditure. There is therefore a need for solutions which, on the one hand, permit at least partially automated guidance of a transportation vehicle and, on the other hand, limit the scope of the technical requirements so that the requirements can also be implemented in a lower or medium price segment.

The method which is proposed in US 2015/0154871 A1 for controlling movement of a group of transportation vehicles on a roadway provides that one or more following transportation vehicles are controlled by a control device of a lead transportation vehicle, wherein the transportation vehicles move as one unit with a variable form and cooperate with one another.

DE 10 2012 212 681 A1 describes a method for automatically guiding transportation vehicles. In this context, the following transportation vehicle receives a target position relative to a lead transportation vehicle, as well as route data about the route which is to be travelled along by the lead transportation vehicle. On-board sensing devices of the following transportation vehicle also sense the path travelled along by the lead transportation vehicle, and tracking data are generated on the basis of these data. A level of accuracy is determined by comparing the route data and the tracking data. Then, autonomous control of the following transportation vehicle with respect to the target position relative to the lead transportation vehicle is carried out on the basis of the level of accuracy.

In the method described in US 2013/0079953 A1, transportation vehicles are guided in a convoy behind a lead transportation vehicle. Data about the maximum permitted and the current number of transportation vehicles in the convoy are transmitted. It is determined whether a transportation vehicle of the convoy is blocking the signal, and such a transportation vehicle becomes a pseudo lead transportation vehicle of a sub-convoy. In this way, a newly added following transportation vehicle can receive data from other following transportation vehicles.

In the method, described in US 2015/0127189 A1, for automatically tracking a following vehicle on the lane of a lead vehicle, the lead vehicle transmits route information and first coordination information to the following vehicle. Driving conditions of the lead vehicle are sensed by surrounding sensors of the following vehicle, and on the basis of this information second coordination information is generated. The first and second coordination information items are compared and autonomous tracking is executed if they correspond.

US 2015/0153733 A1 describes a control device for a vehicle which can detect a state of incapacity to drive and can initiate automatic guidance behind a lead vehicle. The lead vehicle leads the following vehicle to a target position, for example, a car park or a hospital.

In a similar way, in the case of the system described in US 2016/0071418 A1 an emergency in the case of a vehicle is detected, and a request for help is transmitted. A lead vehicle transmits navigation instructions on the basis of which the vehicle is automatically controlled. In this context, the search for a lead vehicle can be mediated via a central control center.

Disclosed embodiments permit a flexible and easy-to-way to perform automatic travel with a method and a system for providing at least partially automatic guidance of a following transportation vehicle.

According to the disclosed embodiments, this is achieved by the disclosed method and the disclosed system.

In the disclosed method of the type specified at the beginning, availability data of at least one lead transportation vehicle are acquired. In addition, request data of the following transportation vehicle are acquired, and on the basis of the availability data and the request data, offer data about the lead transportation vehicle are generated and are transmitted to the following transportation vehicle. An offer output is generated and output on the basis of the offer data, wherein the outputting is carried out in the following transportation vehicle. A user input is acquired, and acceptance data are generated on the basis of the user input. In addition, tracking data are generated and transmitted to the following transportation vehicle. The following transportation vehicle is guided at least partially automatically behind the lead transportation vehicle on the basis of the tracking data.

As a result, the following transportation vehicle may be provided with a suitable lead transportation vehicle, to permit at least partially automatic guidance. In addition, benefits for the consumption of energy or fuel of the following transportation vehicle can be utilized, the benefits occurring, for example, as a result of automatic tracking in the wind shadow of the lead transportation vehicle. In addition, the disclosed method can constitute an intermediate stage on the way toward the autonomous, fully automatic guidance of transportation vehicles, wherein users are to be provided with a confidence-inducing alternative.

The disclosed method can provide a wide range of purchases with the possibility of driving their own transportation vehicle with a high degree of automation without their own transportation vehicle being capable of driving with such a degree of automation in a technically independent, that is to say completely autonomous state. Electronic coupling of the following transportation vehicle to the lead transportation vehicle is carried out, in which case the function of the lead transportation vehicle is to be considered as analogous to towing a caravan. These can be provision that it can be selected that the following transportation vehicle be equipped, for example, for implementing the method as an additional option, for example, referred to as “platooning capable”. In this case, significantly reduced equipment of the following transportation vehicle with sensors and actuators compared with the requirements for completely autonomous driving is sufficient. Such equipment versions are already commercially available and can be offered at significantly reduced system costs.

The method provides that under specific conditions the following transportation vehicle can be electronically coupled to a transportation vehicle travelling ahead, referred to as a “platoon leader” or “lead transportation vehicle”. Lead transportation vehicles can be in principle any other transportation vehicles, for example, passenger cars, trucks and buses. After the coupling, the following transportation vehicle is automatically controlled in such a way that it travels behind the lead transportation vehicle. This provides, in particular, the driver of the following transportation vehicle with the benefit of being able to carry out secondary activities, for example, reading or making a telephone call, during the automatic tracking. Furthermore, a small degree of automation can be provided during which the driver of the following transportation vehicle continues, for example, to monitor the traffic but is not continuously actively involved in the guidance of the following transportation vehicle.

The at least one lead transportation vehicle can be controlled by a driver or fully autonomously. In the case of the disclosed method, availability data of a multiplicity of lead transportation vehicles are acquired.

The acquisition of the availability data, which are generated by the at least one lead transportation vehicle, is carried out here in a manner known per se. There can be provision that a potential lead transportation vehicle automatically provides availability data or that the provision takes place manually, for example, by an operator control action of a driver of the lead transportation vehicle. In addition, the availability data can be provided by the lead transportation vehicle on request. The availability data of the lead transportation vehicle can be transmitted by a data-transmitting connection to an acquisition unit, for example, by a wireless network, a mobile radio network or by other data-transmitting methods or mechanisms which are known per se.

By the disclosed method, available lead transportation vehicles may be communicated to the following transportation vehicles on request. In contrast to known solutions which describe tracking of a following transportation vehicle behind a lead transportation vehicle, the disclosed embodiments also permit flexible assignment of suitable lead transportation vehicles over and above this even if the lead transportation vehicles cannot yet directly assume the guidance at a specific point in time, for example, because the transportation vehicles are too far away from one another or because a route is just being planned. The disclosed embodiments provide for this purpose that provision of offer data which are transmitted to the following transportation vehicle. In this way, information about available lead transportation vehicles can be provided to the driver of the following transportation vehicle, and the driver can actively bring about the generation of the acceptance data by a user input. For example, in this way it is possible to offer a selection of various lead transportation vehicles, from which the user can accept a suitable offer. If various lead transportation vehicles are available, different conditions for the tracking can be compared. This provides the user of the following transportation vehicle with the benefit that the lead transportation vehicle cannot only be assigned from the outside but also self-selected.

In at least one exemplary embodiment of the disclosed method, the availability data of the at least one lead transportation vehicle comprise a current position, a planned route and/or a maximum number of permitted following transportation vehicles. This makes available relevant information for at least partially automatic guidance of the following transportation vehicle behind the lead transportation vehicle.

A planned route of the lead transportation vehicle which is included in the availability data can comprise, for example, information about a target position and/or one or more planned intermediate positions which are to be travelled to on the way to the target position. In addition, further information can be included, for example, about the types of road which are included by the planned route, that is to say whether, for example, freeways are to be travelled on.

There is provision that a lead transportation vehicle can carry out tracking for a plurality of following transportation vehicles. The maximum number of following transportation vehicles which is permitted for a lead transportation vehicle can depend on different conditions, for example, legal restrictions, for example, on a particular necessary transportation permit for the driver of the lead transportation vehicle, technical restrictions, for example, for specific transportation vehicle types as lead transportation vehicles or following transportation vehicles, or preferences of a driver who, for example, wishes to guide only a specific number of transportation vehicles. In addition, the maximum permitted number of following transportation vehicles can depend on the domain, that is to say, for example, on freeways and main roads it is possible to permit a plurality of following transportation vehicles while in the town environment a smaller number is permitted on defined sections of a route, or for example, in heavy work traffic only a single following transportation vehicle is permitted.

There is provision that the following transportation vehicles which are assigned to a lead transportation vehicle are known to the lead transportation vehicle, wherein at least the number of coupled and therefore tracked following transportation vehicles (also referred to as “platoon members”) is available.

In addition, there can be provision that further information about the assigned following transportation vehicles, for example, about a system state or a route for which the tracking is planned, are available in the lead transportation vehicle.

Alternatively or additionally, the availability data can also comprise information about a current direction of movement and/or speed of the lead transportation vehicle. In addition, information about a type and/or the model of the lead transportation vehicle can be included, for example, to differentiate between passenger cars, trucks and buses. In addition, information about preferences of the lead transportation vehicle and/or requirements for potential following transportation vehicles can be included in the availability data, for example, if a lead transportation vehicle is not compatible with following transportation vehicles of a specific type.

The request data are generated and made available by the following transportation vehicle. The acquisition of the request data of the following transportation vehicle can take place in a manner known per se. The request data are acquired in the same way as the availability data. The following transportation vehicle can automatically make available the request data here, for example, if specific conditions are satisfied. In addition, the request data can be made available manually, for example, as a function of an operator control action of a driver of the following transportation vehicle. The request data can be acquired by an acquisition device by the same acquisition device by which the availability data are also acquired. The acquisition can be carried out here by a data-transmitting connection, for example, of a wireless network, a mobile radio network or by other data-transmitting method or mechanism which are known per se.

In a further exemplary embodiment of the disclosed method, the request data of the following transportation vehicle comprise a current position and/or a planned route. As a result, particularly relevant request data can be generated for the following transportation vehicle.

The information about a planned route of the following transportation vehicle can comprise, for example, information about a target position and/or one or more planned intermediate positions which are to be driven to on the way to the target position. In addition, further information can be included, for example, about the road types included in the planned route, that is to say whether, for example, autoroutes are to be travelled on.

Alternatively or additionally, the request data can comprise information about a current direction of movement and/or speed of the following transportation vehicle. In addition, information about type and/or the model of the following transportation vehicle can be included, for example, to differentiate between passenger cars, trucks and buses. In addition, information about preferences of the following transportation vehicle and/or requirements for a potential lead transportation vehicle can be included in the request data, for example, if a following transportation vehicle is not compatible with a lead transportation vehicle of a specific type.

In one development, the request data are generated automatically during a route planning operation of a navigation system. As a result, the request data may be formed in such a way that lead transportation vehicles can be determined with a particularly high relevance for a specific route which is generated for the following transportation vehicle.

The navigation system is included here in the following transportation vehicle. Alternatively or additionally, there can be provision that the navigation system is included in a mobile user device by which route planning is carried out for the following transportation vehicle, or that the route planning is carried out by a further external unit, for example, by an external server. In the latter case, a planned route can be transmitted to the following transportation vehicle and/or the route planning can be carried out at a time before the journey is started, outside the following transportation vehicle, for example, by an Internet page as an interface with the external unit.

In addition, the request data can be transmitted automatically during the route planning, for example, to a unit which is already provided for acquiring the availability data in the above-explained operation of the disclosed method.

In one development, the request data are generated on the basis of a further user input. Alternatively or additionally, acquisition of the request data takes place as a function of the further user input. This permits the generation and/or provision of the request data to be triggered in a targeted state, for example, on the basis of an operator control action which is sensed by a device of the following transportation vehicle.

The request data, which are generated according to the disclosed embodiments on the basis of the availability data of the at least one lead transportation vehicle and on the basis of the request data of the following transportation vehicle, include information as to when and under which conditions a relevant lead transportation vehicle is available for the following transportation vehicle. The request data comprise information which can be understood as offers of potential lead transportation vehicles which offer the possibility of permitting the coupling and automatic tracking of the following transportation vehicle. In addition, information about a price, specific further conditions and/or further information about the lead transportation vehicle can be included. The offer data comprise information about further accompanying transportation vehicles which are possible for automatic guidance of the following transportation vehicle.

The offer data may be output to a user, in particular, the driver of the following transportation vehicle, by outputting an offer. For example, there is provision here that available free lead transportation vehicles are displayed. In this context, in particular, further information, for example, the target positions of the relevant lead transportation vehicles, are also output.

In at least one further disclosed embodiment, when the offer output is output, a graphic representation of a route with information about the at least one lead transportation vehicle is displayed. Information about a multiplicity of lead transportation vehicles is displayed. As a result, the offer output may be represented in such a way that potential lead transportation vehicles which can permit the following transportation vehicle to carry out at least partially automatic tracking are displayed in a way which can be perceived particularly easily and quickly.

The graphic representation of the offer output is also generated on the basis of data of a navigation system which is included, for example, in the following transportation vehicle, a mobile user device or an external device. In this context, the graphic representation comprises a representation of a traffic route network, for example, by a customary map representation. The graphic representation can also comprise a route which is planned for the following transportation vehicle, for example, on the basis of emphasizing traffic routes, the use of which is planned when the route is travelled along. It can additionally comprise information about routes which are assigned to the lead transportation vehicles, as well as about positions of the following transportation vehicle and the lead transportation vehicles.

According to the disclosed embodiments, in a further operation, a user input is acquired, and acceptance data are generated as a function of the user input. The acceptance data can subsequently be transmitted to the at least one lead transportation vehicle, wherein the transmission can occur in a manner known per se directly to the lead transportation vehicle or indirectly via an external device, for example, a server. In this way, for example, a lead transportation vehicle can be selected to inform it about a docking request of the following transportation vehicle which the lead transportation vehicle can in turn accept, for example, in what is referred to as a “handshake” method.

In one development, the user input is acquired by activating a control button of a graphic user interface, by activating an analog switch or on the basis of a voice command. A specific potential lead transportation vehicle is selected on the basis of the user input, and tracking of the following transportation vehicle behind the lead transportation vehicle is started.

In one development, in addition a tracking confirmation of the lead transportation vehicle is acquired and transmitted to the following transportation vehicle. As a result, confirmation or rejection of the lead transportation vehicle may be taken into account, to permit automatic guidance of the following transportation vehicle by tracking behind the lead transportation vehicle.

The tracking confirmation can be acquired on the basis of an operator control action of a driver of the lead transportation vehicle. In addition, an output which communicates to the driver of the lead transportation vehicle that request data of a following transportation vehicle are present can be generated for the lead transportation vehicle and output. This outputting for the lead transportation vehicle can additionally comprise information about the following transportation vehicle and/or its travel, for example, about the planned route or target position of the following transportation vehicle.

Transmission of the tracking confirmation to the following transportation vehicle can occur directly on the basis of a data-transmitting connection between the lead transportation vehicle and the following transportation vehicle or on the basis of another method which is known per se, for example, via an external server.

In a further operation, the tracking data are generated and transmitted to the following transportation vehicle. The tracking data comprise information which permit the following transportation vehicle to drive at least partially automatically behind the lead transportation vehicle. The following transportation vehicle is guided behind the lead transportation vehicle in the same lane on the basis of the tracking data. For this purpose, devices of the following transportation vehicle are actuated on the basis of the tracking data in such a way, that the direction and speed of the following transportation vehicle are controlled in accordance with the movement of the lead transportation vehicle. In this context, in particular devices for changing a steering angle, an acceleration or deceleration, a chassis controller, a transmission controller, a controller for an electric drive, a system for controlling an energy store and/or further devices of the following transportation vehicle are used.

The tracking data generated according to the disclosed embodiments are generated, in particular, by the lead transportation vehicle. Alternatively or additionally, tracking data can be generated by a further device, for example, an external tracking device. In addition, tracking data can alternatively or additionally be generated by the following transportation vehicle itself.

In addition there can be provision that the tracking data are generated by the following transportation vehicle, for example, if the movements of the lead transportation vehicle are sensed by sensors of the following transportation vehicle, and the tracking occurs on the basis of these data.

In at least one exemplary embodiment of the disclosed method, the tracking data comprise information for guiding the following transportation vehicle to a target position relative to the lead transportation vehicle. As a result, the following transportation vehicle may be navigated from a current position to a position which is suitable for the at least partially automatic tracking. There is provision here that the at least partially automatic tracking is not carried out until the following transportation vehicle has reached the target position relative to the lead transportation vehicle.

The guiding of the following transportation vehicle with respect to the target position relative to the lead transportation vehicle occurs manually by the driver of the following transportation vehicle or at least partially automatically. For example, the tracking data can comprise information which is output to the driver as navigation instructions on the basis of which he can steer the following transportation vehicle to the target position relative to the lead transportation vehicle. At this target position, the virtual coupling of the following transportation vehicle to the lead transportation vehicle can occur, that is to say after the target position has been reached the following transportation vehicle can be guided automatically behind the lead transportation vehicle.

The target position relative to the lead transportation vehicle can be determined here in various ways. For example, a predefined or flexibly determined spatial offset relative to the lead transportation vehicle can be taken into account, for example, to determine the target position at a specific distance behind the lead transportation vehicle. In this case, the spatial offset can be selected in such a way that sensors of the following transportation vehicle can track movements of the lead transportation vehicle essentially without interruption and/or a data-transmitting connection between the lead transportation vehicle and the following transportation vehicle cannot be interrupted. The distance can be selected in such a way that a further transportation vehicle is prevented from cutting in or travel of the following transportation vehicle in the wind shadow of the lead transportation vehicle or of a following transportation vehicle is made possible.

In a further disclosed embodiment, during the automatic guidance of the following transportation vehicle, data on the surroundings are acquired by following transportation vehicle sensors, and plausibility of the tracking data is checked on the basis of the acquired data on the surroundings. As a result, the safety of the travel may be improved by monitoring the safety of the travel on the basis of data which are acquired by sensors of the following transportation vehicle. The automatic guidance of the following transportation vehicle can be aborted if it is detected that the tracking data do not correspond to the actual movement of the lead transportation vehicle or automatic travel on the basis of the tracking data would bring about a dangerous situation for the following transportation vehicle. The control by the following transportation vehicle can in this case be returned to a driver of the following transportation vehicle and/or a safe travel mode can be initiated in which, for example, the speed of the following transportation vehicle is reduced and a safe stopping position is driven to.

In a further development, in addition a payment module determines a tracking price and an account which is assigned to the following transportation vehicle is debited as a function of the determined tracking price. This occurs as a function of the route on which the following transportation vehicle is automatically steered behind the lead transportation vehicle, and/or as a function of a type of the lead transportation vehicle or following transportation vehicle.

The disclosed method can be used in this way to implement the use of a lead transportation vehicle to be automatically followed by the lead transportation vehicle as a cost-effective service. For example, the following transportation vehicle can incur costs for the use of the lead transportation vehicle, while a payment is made for the guidance of the lead transportation vehicle.

For example, specific transportation vehicles can be used as lead transportation vehicles, which are assigned, for example, to taxi companies, bus companies or logistics companies. In this case, it can be additionally provided that a lead transportation vehicle can be reserved for use by a following transportation vehicle, for example, on a specific section of a route. In addition, there can be provision that a lead transportation vehicle is requested to permit the following transportation vehicle to perform at least partially automatic guidance along a specific route. It is therefore possible, for example, for a lead transportation vehicle to be requested to pick up a user from a specific starting position and drive to a specific target position, wherein for the user of the following transportation vehicle the comfort of his own transportation vehicle is ensured instead of the use of another transportation vehicle.

In addition, various payment models, for example, a free use of lead transportation vehicles with which the following transportation vehicle can spontaneously initiate automatic guidance of a lead transportation vehicle, as well as charge-incurring reservation or provision of a lead transportation vehicle for planned routes. In this context there can be provision that services of specific lead transportation vehicles can be used in any desired scope for payment of a flat rate. In addition, there can be provision that a particular lane, comparable, for example, to a known bus lane, is released exclusively for the automatic guidance, to control the traffic flow or to ensure orderly conditions in the case of special events, for example, if travel through the area is permitted only in conjunction with automatic tracking. Use of such a lane can also be configured in a charge-incurring state.

For example, the automatic tracking can be switched via a portal which can provide data about lead transportation vehicles as well as about the routes on which they are currently travelling or which are planned in the future and can reserve specific lead transportation vehicles for potential following transportation vehicles in a charge-incurring state. The sections of the routes can be reserved. In this context it is also possible to bring about association with the portal even independently of a specific following transportation vehicle which a driver uses. In addition, further charge-incurring services can be offered, for example, in that a lead transportation vehicle is offered exclusively for booking for a specific, predefined section of a route and is, if appropriate, provided. The provision of the lead transportation vehicle can be carried out by any desired providers, wherein the switching takes place centrally via the portal. In this way various pricing models, for example, method or mechanism of flat rates, can be implemented.

In one development, the availability data are acquired and stored by a switching device, and the offer data are generated by the switching device. As a result, central administration of availability data of a lead transportation vehicle and, in particular, of a multiplicity of lead transportation vehicles may be carried out, for example, by an external server to which following transportation vehicles and lead transportation vehicles can establish a data-transmitting connection.

The availability data which are stored by the switching device can be continuously updated, for example, by deleting availability data which have been acquired before a specific time. As a result, information about the availability of lead transportation vehicles as well as about the lead transportation vehicles themselves can be made available on a continuously updated basis. If the request data of the following transportation vehicle are then received, the request data can thus be generated on the basis of the stored availability data. For example, it is possible to determine which lead transportation vehicles are located in the reachable proximity of the following transportation vehicle and can travel along a section of a route which is relevant for the following transportation vehicle. In addition it is possible to determine which lead transportation vehicles have the same target position or which travel along the same section of a route as the following transportation vehicle. In addition it is possible to evaluate how well various lead transportation vehicles match the request data of the following transportation vehicle. In this context, for example, a lead transportation vehicle is evaluated as the most suitable if immediate transfer of the tracking of the following transportation vehicle as far as its target position is possible, while another lead transportation vehicle which can only carry out the tracking along a partial section of the route planned for the following transportation vehicle or which is located at a distance from the following transportation vehicle so that it initially has to be steered to a target position relative to the lead transportation vehicle, for example, by the driver of the following transportation vehicle, is less suitable.

In at least one disclosed embodiment, the request data are generated and transmitted automatically if registration of the following transportation vehicle has been registered for the switching device. As a result, the switching device may be operated as a portal for switching automatic tracking, wherein following transportation vehicles and, if appropriate, also lead transportation vehicles can be identified by a registration method which is known per se, for example, by a login or some other authentication method. This also facilitates the above-explained configuration for charging for the tracking.

Registration takes place during the planning of the route of the following transportation vehicle, so that lead transportation vehicles which can permit the following transportation vehicle to perform at least partially automatic travel along the planned route can be planned in advance and, if appropriate, reserved or provided. The following transportation vehicle can be registered here continuously for the switching device, or one-off registration, for example, in the case of route planning, can be performed. A data-transmitting connection between the following transportation vehicle and the switching device can be established as a function of the registration, continuously, temporarily or at specific times.

In at least one further disclosed embodiment, the acceptance data are transmitted from the following transportation vehicle to the switching device, and the switching device establishes a data-transmitting connection of the following transportation vehicle to the lead transportation vehicle. This connection can be established here directly or indirectly by the switching device. As a result, the switching device may also establish a data-transmitting connection to lead transportation vehicles which do not permit a direct connection set-up to following transportation vehicles, for example, for reasons of safety.

In one development, the offer output by the switching device is generated and transmitted to the following transportation vehicle. This is done as an alternative to generation to the offer output by the following transportation vehicle itself. As a result, the processing of the offer data may be facilitated by the following transportation vehicle. For example, an offer output with graphics data can be transmitted to the following transportation vehicle and output by the latter there.

The disclosed system of the type specified at the beginning comprises an acquisition unit by which availability data of at least one lead transportation vehicle and request data of the following transportation vehicle can be acquired. The system also comprises an offer unit by which offer data about the lead transportation vehicle can be generated on the basis of the availability data and the request data and can be transmitted to the following transportation vehicle, as well as a computing unit by which an offer output can be generated on the basis of the offer data, and an output unit by which the offer output can be output. The system additionally comprises an input unit by which a user input can be acquired, wherein acceptance data can be generated on the basis of the user input. The system also comprises a tracking unit by which tracking data can be generated and transmitted to the following transportation vehicle, as well as a control unit by which the following transportation vehicle can be guided at least partially automatically behind the lead transportation vehicle on the basis of the tracking data.

The disclosed system is designed to implement the method according to the embodiments as described above. The system therefore has the same benefits as the disclosed method.

In at least one exemplary embodiment of the disclosed system, in addition, a planned route of the following transportation vehicle can be generated by a navigation system, and the request data can be generated automatically on the basis of the planned route. As a result, a suitable lead transportation vehicle for tracking the following transportation vehicle may be used.

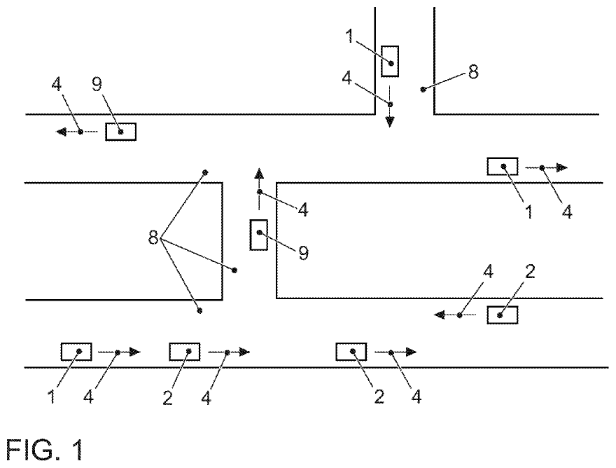

With reference to FIG. 1, a traffic situation is explained in which the disclosed method can be executed.

A road network 8 on which a multiplicity of transportation vehicles are located whose directions of travel are indicated by arrows 4 is illustrated. These transportation vehicles include following transportation vehicles 1, lead transportation vehicles 2 and further transportation vehicles 9. This differentiation relates to different technical equipment of the respective transportation vehicles which permits automatic tracking of the following transportation vehicles 1 by lead transportation vehicles 2, while further transportation vehicles 9 do not have any suitable equipment and therefore do not occur either as lead transportation vehicles 2 or as following transportation vehicles 1.

The disclosed method, which is explained in detail below, provides the following transportation vehicles 1 with information about respectively relevant lead transportation vehicles 2 and can initiate automatic tracking of a following transportation vehicle 1 behind, in each case, one lead transportation vehicle 2. A challenge here is, as is apparent in FIG. 1, that not all lead transportation vehicles 2 are possible for the automatic guidance of all the following transportation vehicles 1, for example, because they drive in different directions 4 and/or have planned different routes. In addition, further conditions may be present which are to be taken into account when carrying out tracking, for example, different transportation vehicle types. The disclosed embodiments therefore provide that request data of the following transportation vehicles 1 and availability data of the lead transportation vehicles 2 are acquired, and offer data which are relevant for the following transportation vehicles 1 and on the basis of which automatic tracking can be further established are respectively made available to the following transportation vehicles 1.

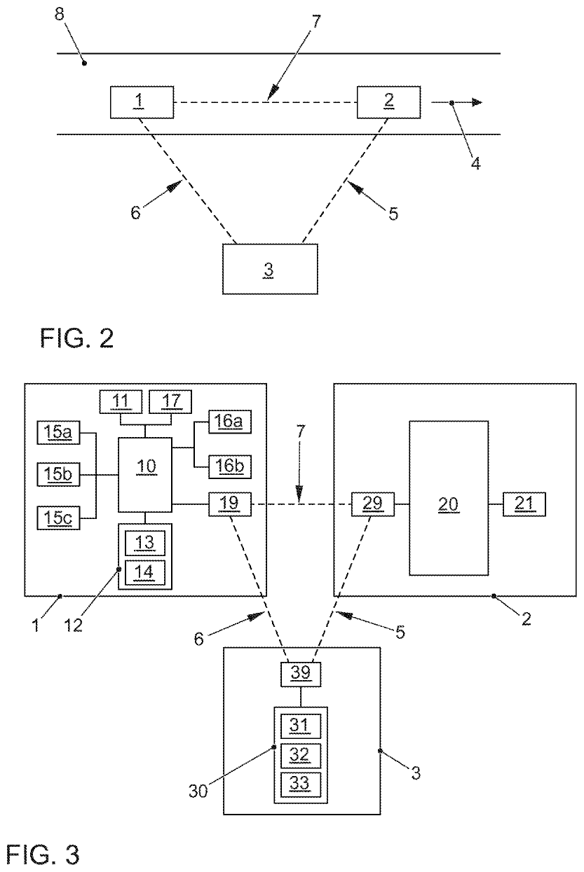

The exchange of data which is provided in the disclosed method takes place by a network which in the exemplary embodiment explained below comprises a switching device. Such a network between transportation vehicles and a switching device for the disclosed method is explained with respect to FIG. 2.

The following transportation vehicle 1, which is driving behind the lead transportation vehicle 2 in the direction of travel 4 is located on the road 8. A data-transmitting connection 7 which is indicated by a dashed line is present between the following transportation vehicle 1 and the lead transportation vehicle 2.

In addition, a switching device 3, which is connected to the following transportation vehicle 1 by a first data-transmitting connection 6 and to the lead transportation vehicle 2 by a second data-transmitting connection 5 is also provided. The data-transmitting connections 5, 6, 7 can be established here in different ways which are known per se, in particular, by a mobile radio network. In addition there can be provision that different types of connection are used alongside one another, for example, by simultaneous use of different data-transmitting connection types, which are referred to as Car2Car and Car2Infrastructure connections. In addition, a data-transmitting connection 5, 6, 7 can be established by a redundant simultaneous use of a plurality of connection types.

In further exemplary embodiments there is provision that the data-transmitting connection 7 between the following transportation vehicle 1 and the lead transportation vehicle 2 is established indirectly by the switching device 3, wherein the direct connection 7 is replaced in this case by the data-transmitting connection 6 of the following transportation vehicle 1 and the data-transmitting connection 5 of the lead transportation vehicle 2, to the switching device 3. The data-transmitting connections 5, 6, 7 can also be established in different ways in further exemplary embodiments.

The schematic illustration in FIG. 2 is to be understood as not to scale here, in particular, with respect to the illustrated distances.

An exemplary embodiment of the disclosed system is explained in detail with respect to FIGS. 2 and 3. Here, a traffic situation like that explained above with respect to FIG. 1 is assumed.

The following transportation vehicle 1 comprises a control unit 10 to which a computing unit 11, a navigation system 17 and a communication unit 19 are coupled. In addition, a touch screen 12, which comprises an output unit 13 and an input unit 14, is coupled to the control unit 10. The output unit 13 is embodied here as a display face, while the input unit 14 comprises a touch-sensitive surface which extends over the display face of the output unit 13.

The following transportation vehicle 1 also comprises driver assistance systems 15a, 15b, 15c which are coupled to the control unit 10 and are formed in a manner known per se. For example, a lane-keeping assistant, a cruise control system, an adaptive cruise control system, a lane-changing assistant and an automatic controller of a transmission, a chassis controller and/or another system can also be included. Furthermore, following transportation vehicle sensors 16a, 16b, which are also formed in a manner known per se, are coupled to the control unit 10. For example, detection systems based on ultrasonic sound, radar, lidar and/or cameras for capturing infrared light and visible light can also be provided.

The driver assistance systems 15a, 15b, 15c assist a driver when driving the following transportation vehicle 1 in different ways at least partially automatically. Without the driver assistance systems 15a, 15b, 15c the driver directly influences the movement of the following transportation vehicle 1. Signals or movements of operator control elements which are activated by the driver, such as the pedal system, the gear shift or the steering wheel, are transmitted, if needs be, to corresponding devices which influence the locomotion of the following transportation vehicle 1. Such locomotion of the following transportation vehicle 1 corresponds to the smallest degree of automation. In the case of a higher degree of automation, for the most part there is also automatic intervention into devices which serve for the locomotion of the transportation vehicle 1. For example, there is intervention into the steering system for the following transportation vehicle 1 or the acceleration in a positive or negative direction. In the case of an even higher degree of automation, which is, however, associated with considerable technical expenditure on sensor systems and control systems, there is intervention in devices of the following transportation vehicle 1 to the extent that, for example, routes of a navigation system can be driven along essentially automatically.

It is to be noted at this point that although the driver can increasingly give up control of the guidance of the transportation vehicle by selecting a high degree of automation, he can immediately recover this control by active steering or activation of the pedal system.

The disclosed embodiments provide, a medium-ranking degree of automation during the travel of the following transportation vehicle 1, which degree can be achieved with relatively limited technical method or mechanism. In the exemplary embodiment, the driver assistance systems 15a, 15b, 15c of the following transportation vehicle 1 are therefore configured in such a way that completely autonomous guidance in the sense of a maximum degree of automation can take place, but that so many interventions can be made into the guidance of the following transportation vehicle 1 by the driver assistance systems 15a, 15b, 15c that automatic guidance behind the lead transportation vehicle 2 can be carried out using externally provided tracking data.

The driver assistance systems 15a, 15b, 15c are also embodied in such a way that monitoring of safety-relevant facets of the travel of the following transportation vehicle 1 can be carried out, for example, a distance from other road users and/or other sources of danger, correspondence of the speed to prescribed courtesy limitations, and keeping to a predefined lane of the road 8 and/or other facets.

The lead transportation vehicle 2 comprises a control unit 20 to which a communication unit 29 and a tracking unit 21 are coupled. In the exemplary embodiment, the lead transportation vehicle 2 is steered by a human driver who is, if appropriate, assisted by driver assistance systems of the lead transportation vehicle 2. In further exemplary embodiments there can be provision that the lead transportation vehicle 2 is guided completely automatically.

A data-transmitting connection 7 is established between the following transportation vehicle 1 and the lead transportation vehicle 2 by the respective communication units 19, 29. As already explained above, this data-transmitting connection 7 can be established in various ways which are known per se wherein a continuous or temporary data-transmitting connection 7 can be present. The data-transmitting connection 7 can be established directly or by a further unit, for example, in the case of a data-transmitting connection 7 which is switched through a mobile radio network.

The switching device 3 also comprises a communication unit 39 which is coupled to a control unit 30. The control unit 30 of the switching device 3 comprises an acquisition unit 31, an offer unit 32 and a payment module 33.

Data-transmitting connections 5, 6 to the lead transportation vehicle 2 or the following transportation vehicle 1 can be established by the communication unit 39 of the switching device 3. As already explained above, this can be done in various ways which are known per se.

An exemplary embodiment of the disclosed method is explained with reference to FIGS. 2 and 3. In this context, the above-explained exemplary embodiment of the disclosed system is assumed and is explained in detail.

In a first operation, availability data of the lead transportation vehicle 2 are acquired. In the exemplary embodiment this is carried out by the acquisition unit 31 of the switching device 3, wherein a data-transmitting connection 5 to the lead transportation vehicle 2 is established by the communication device 39. The lead transportation vehicle 2 then provides availability data which comprise the current position and the current route of the lead transportation vehicle 2. In addition, information of the lead transportation vehicle 2 is included which indicates the maximum number of following transportation vehicles 1 which can be tracked by the lead transportation vehicle 2.

In a general case, the availability data are acquired by a multiplicity of lead transportation vehicles 2, for example, by all the lead transportation vehicles 2 which are registered at the switching device 3. In further exemplary embodiments, there can additionally be provision that availability data are acquired for lead transportation vehicles 2 which currently travel along a specific route and which have planned a journey in the future and/or which can travel along the route when necessary, for example, on order.

In various disclosed embodiments, the acquisition of the availability data can occur in different ways, for example, by a request of the switching device 3 to the lead transportation vehicle 2 and/or by automatic transmission of the availability data of the lead transportation vehicle 2 to the switching device 3. In addition there can be provision that availability data are carried out by an input of a user, for example, by inputting relevant data via an interface, for example, a website of the acquisition unit 31.

In addition, request data of the following data 1 are acquired by the acquisition unit 31 of the switching device 3. The request data can be generated in a similar way by the following transportation vehicle 1 and acquired by the acquisition unit 31 in a way described above for the availability data of the lead transportation vehicle 2. The request data of the following transportation vehicle comprise the current position and the planned route of the following transportation vehicle 1. The request data are generated automatically in the exemplary embodiment, while route planning is carried out by the navigation system 17 of the following transportation vehicle 1. In further exemplary embodiments there can be provision that the request data are generated if a user, for example, the driver of the following transportation vehicle 1, makes a specific input, for example, by operating a device of the following transportation vehicle 1, by a mobile user device and/or on the basis of an input of the relevant data via an interface of the acquisition unit 31.

In a further operation, offer data are generated by the lead transportation vehicle 2 on the basis of the availability data and the request data and transmitted to the following transportation vehicle 1. The generation of the offer data occurs in the exemplary embodiment by the offer unit 32 of the switching device 3 and the transfer of the offer data occurs via the data-transmitting connection 6.

The offer data comprise information about lead transportation vehicles 2 which has been determined as relevant for the following transportation vehicle 2 on the basis of the availability data and the request data. Lead transportation vehicles 2 which are located in the spatial proximity of the following transportation vehicle 1 and travel along an at least similar or identical route to the following transportation vehicle 1 are taken into account. For example, the offer data can comprise information about lead transportation vehicles 2 which travel along at least one section of the route which is planned for the following transportation vehicle 1, at the same time as the following transportation vehicle 1, or which have signaled their readiness to travel along this section of the route.

An offer output is generated on the basis of the offer data and output in the following transportation vehicle 1 by the output unit 13. In this context a graphic representation is generated which comprises a representation of a road network with the route planned for the following transportation vehicle 1, as well as with information about the lead transportation vehicles 2. Information about the lead transportation vehicles 2 relates to information as to which route is being travelled along, which requirements are made at potential following transportation vehicles 1, which different types of lead transportation vehicle 2 are available and other relevant information.

In a further operation, a user input is acquired, and acceptance data are generated on the basis of the user input. In the exemplary embodiment, the outputting is carried out by the touch screen 12 whose input unit 14 is embodied as a touch-sensitive surface. In this way, user input can be made on the basis of direct operation of control buttons of a graphic operator control interface, which includes the offer output. In further exemplary embodiments in which the generation of the request data is carried out automatically by the navigation system 17, the user input can comprise, for example, confirmation of route planning by the user. In other exemplary embodiments, the user input can be acquired in a different way.

Generated acceptance data comprise information as to whether automatic guidance of the following transportation vehicle 1 is to be started by the lead transportation vehicle 2. In addition, it is possible to include further information, for example, as to which route or which section of a route the acceptance data relate to.

In the exemplary embodiment, the acceptance data are transmitted to the lead transportation vehicle 2 indirectly via the switching device 3. In further exemplary embodiments, acceptance data can alternatively or additionally be transmitted between the following transportation vehicle 1 and the lead transportation vehicle 2 via a direct transmission by the data-transmitting connection 7 thereof. In this case it is necessary to identify the lead transportation vehicle 2, for example, on the basis of the information included in the offer data, to be able to set up the data-transmitting connection 7.

In a further exemplary embodiment there is additionally provided that a tracking confirmation of the lead transportation vehicle 2 is acquired and transmitted to the following transportation vehicle 1. This can be done, for example, on the basis of input of a driver of the lead transportation vehicle 2 which approves the guidance of the following transportation vehicle 1 behind the lead transportation vehicle 2. In addition there can be provision that a communication is established between occupants of the lead transportation vehicle 2 and of the following transportation vehicle 1, for example, by voice messages, text messages or in some other way. The tracking confirmation can also be transmitted directly from the lead transportation vehicle 2 to the following transportation vehicle 1 or can be administered via the switching device 3.

To guide the following transportation vehicle 1 automatically behind the lead transportation vehicle 2, tracking data are generated and transmitted to the following transportation vehicle 1. In the exemplary embodiment, this generation is carried out by the lead transportation vehicle 2. Alternatively or additionally, it is possible, however, for tracking data also to be generated and provided by the switching device 3. The transmission of the tracking data is carried out in the exemplary embodiment directly via the data-transmitting connection 7 from the lead transportation vehicle 2 to the following transportation vehicle 1, and alternatively or additionally indirect transmission can occur via the switching device 3.

The tracking data comprise information about a target position of the following transportation vehicle 1 relative to the lead transportation vehicle 2. In the situation shown in FIG. 2 there is provision that the following transportation vehicle 1 is located at a short distance behind the lead transportation vehicle 2. If the automatic guidance of the following transportation vehicle 2 is started, information which permits the driver assistance systems 15a, 15b, 15c of the following transportation vehicle 1 to control the movement of the following transportation vehicle 1 in such a way that the predefined position relative to the lead transportation vehicle 2 is assumed, is provided in a manner known per se on the basis of the tracking data. This can be, for example, a position at a specific distance behind the lead transportation vehicle 2, wherein in the exemplary embodiment there is provision that a short distance is assumed such that cutting in of other transportation vehicles between the following transportation vehicle 1 and the lead transportation vehicle 2 is avoided. In further exemplary embodiments, the position of the following transportation vehicle 1 relative to the lead transportation vehicle 2 can be formed in a different way, for example, with a lateral offset relative to the trajectory travelled along by the lead transportation vehicle 2, or such that energy savings are optimized by driving of the following transportation vehicle 1 in the wind shadow of the lead transportation vehicle 2 or further following transportation vehicles 1.

In the exemplary embodiment there is also provision that the tracking data comprise information as to how the following transportation vehicle 1 can reach the position relative to the lead transportation vehicle 2, in particular, if the position has to be reached before the start of the automatic tracking. This is relevant if there is a relatively large spatial distance between the following transportation vehicle 1 and the lead transportation vehicle 2, so that the following transportation vehicle 1 cannot be guided immediately directly behind the lead transportation vehicle 2. In this case it is necessary to guide the following transportation vehicle 1 in such a way that it reaches a specific target position relative to the lead transportation vehicle 2, from which position automatic tracking can be started. This guidance can be carried out in various ways which are known per se, in particular, assisted by an output of navigation instructions to the driver of the following transportation vehicle 2. In a further example, it can be indicated to the driver of the following transportation vehicle 1 that a lead transportation vehicle 2 can only be provided at a future time if the lead transportation vehicle 2 firstly has to be requested or if it is located on the route at a position behind the following transportation vehicle 2. In this case, instructions for manual or at least partially automatic guidance of the following transportation vehicle 2 can be generated, as a result of which instructions the following transportation vehicle 2 waits for the lead transportation vehicle 1, for example, by driving to a car park or by reducing the speed of the following transportation vehicle 2, to permit the lead transportation vehicle 1 to overtake.

The following transportation vehicle 1 is now automatically guided behind the lead transportation vehicle 2, and the driver of the following transportation vehicle 1 can, for example, execute secondary activities, for example, reading or making a telephone call. During the automatic tracking behind the lead transportation vehicle 2, the following transportation vehicle sensors 16a, 16b acquire data on the surroundings, and the plausibility of the tracking data is checked on the basis of the acquired data on the surroundings. In this context, it is checked whether the tracking data correspond to the trajectory which is actually being travelled along by the lead transportation vehicle 2. In addition it is checked whether the trajectory of the following transportation vehicle 1 is safe, for example, whether specific minimum distances from sources of danger such as further road users are being complied with.

If it is detected during the plausibility checking of the tracking data that safe automatic tracking is not ensured, in the exemplary embodiment a safe travel mode is activated, that is to say the guidance of the following transportation vehicle 1 is no longer carried out automatically but instead the control is transferred to the driver of the following transportation vehicle 1. Alternatively or additionally, in particular, during a transition time between the automatic tracking and the manual control by the driver of the following transportation vehicle 1, the speed can be reduced and a safe stopping position can be headed for. In addition, signals can be generated and output to signal the end of the automatic tracking and/or the activation of the safe travel mode, for example, for the driver of the following transportation vehicle 1, the driver of the lead transportation vehicle 2, the switching device 3 and/or further road users.

In the exemplary embodiment there is also provision that a value of a tracking price is determined by the payment module 33 of the switching device, and an account which is assigned to the following transportation vehicle is debited as a function of the determined tracking price. In this way, for example, a business model can be implemented in which the automatic tracking represents an offer of service of the lead transportation vehicle 2 to the following transportation vehicle 1. This specific tracking price can be determined here on the basis of various influencing variables, for example, on the basis of the length of the route or of the section of a route along which the automatic tracking is executed, and various pricing models can be implemented.

For example, there can be provision that free spontaneous docking to free lead transportation vehicles 2 can be carried out, wherein the following transportation vehicle 1 can use automatic tracking by a lead transportation vehicle 2 if both transportation vehicles 1, 2 are currently essentially on the same section of a route. In a further example there can be provision that a lead transportation vehicle 2 can be reserved, if, for example, the travel along a specific route by the lead transportation vehicle 2 is already planned in advance. In addition there can be provision that a lead transportation vehicle 2 can be booked for a specific route or a section of a route, wherein, in this case, the lead transportation vehicle 2 is provided specially.

For example, the payment of the tracking price can be made for each individual journey. In a further example, a “flat rate” can be provided as a method of payment, wherein in this case the automatic tracking can be in any desired scope.

In the further exemplary embodiment there can be provision that the switching device 3 switches lead transportation vehicles 2 of a platoon service provider. This can be, for example, a provider of services for automatically tracking following transportation vehicles 1. In addition, for example, taxi companies, bus companies and forwarding companies which have a multiplicity of potential lead transportation vehicles 2 whose planned routes are typically known in a centralized state and which provide tracking. Since in this case the switching device 3 assumes a position between the following transportation vehicle 1 and the platoon service provider, a high level of safety can be achieved since only licensed lead transportation vehicles are switched and a payment model can be implemented by switching by the payment module 33 of the switching device 3.

In the exemplary embodiment there is also provision that the following transportation vehicle 1 and the lead transportation vehicle 2 are registered for the switching device 3. This is done in the exemplary embodiment by a login, that is to say by a method which is known per se and has the purpose of authenticating devices which have a data-transmitting connection 5, 6, 7 to one another. In this context, the switching device 3 provides access to a portal by which interactions necessary for automatic tracking are made possible for transportation vehicles 1, 2 in a manner known per se via a network.

The request data of the following transportation vehicle 1 are generated and transmitted automatically in the exemplary embodiment if the following transportation vehicle 1 has been registered for the switching device 3. The request data are transmitted here from the following transportation vehicle 1 to the switching device 3, and a data-transmitting connection of the following transportation vehicle 1 to the lead transportation vehicle 2 is established by the switching device 3.

In the presented case, the transmission of the request data also takes place automatically during the planning of a route, that is to say the navigation system 17 of the following transportation vehicle 1 automatically brings about a search for suitable lead transportation vehicles 2 which permit automatic tracking of the following transportation vehicle 1. In this context the route planning includes determination of which sections of a route lead transportation vehicles 2 are available on and how these lead transportation vehicles 2 can be reached. In this way, the route can be planned in such a way that the following transportation vehicle 1 can be tracked automatically for a part of the planned route which is as large as possible.

A changeover between various lead transportation vehicle 2 can also be performed at least partially automatically here. For example, the guidance of the following transportation vehicle 1 can be carried out manually by the driver of the following transportation vehicle 1 for a transition of the automatic tracking from a first to a second lead transportation vehicle 2, wherein, for example, navigation instructions can be output. In addition, the guidance of the following transportation vehicle 1 can also take place automatically in this situation, or driver assistance systems 15a, 15b, 15c can assist the guidance of the following transportation vehicle 1. A changeover between two lead transportation vehicles 2 comprises manual or at least partially automatic guidance of the following transportation vehicle 1 to a specific target position relative to the new lead transportation vehicle 2.

In further exemplary embodiments, various operations of the method are not executed automatically but rather follow inputs of a user, in particular, of the driver of the following transportation vehicle 1 or of the lead transportation vehicle 2.

Various exemplary embodiments for the use of the disclosed system are described below:

In a first example, the following transportation vehicle 1 is travelling along a relatively long route, for example, during a holiday journey or a business trip. On a section of a route, for example, on a freeway, the following transportation vehicle 1 is coupled to an available lead transportation vehicle 2 and tracked automatically by it. For this part, secondary activities are now possible for the driver of the following transportation vehicle 1, since he does not have to pay attention to the moving traffic. To achieve a relatively high level of planning safety there can be provision that lead transportation vehicles 1 can be reserved in advance for specific sections of a route in a charge-incurring state for the automatic tracking of the following transportation vehicle 1 via the switching device 3 by a portal, for example, long-distance buses, delivery trucks or similar transportation vehicles.

In a second example, a user is picking up a business partner from the airport. The following transportation vehicle 1 is guided manually by the user himself to the airport, and for the route from the airport to the target position it is guided by a lead transportation vehicle 2 which has been provided at the airport. This can be done, for example, by a taxi company which has suitable lead transportation vehicles 2. During the journey, the following transportation vehicle can already be used as a “mobile office”, wherein the confidential atmosphere is not disrupted by a chauffeur.

In the third example, cooperations with companies for providing lead transportation vehicle 2 are provided, wherein the lead transportation vehicles 2 are switched via the switching device 3 by a portal. For this purpose, the operator of the portal, for example, may charge a fee. In addition to bookable individual journeys, flat rates can also be provided which can lead over a specific running time to a stronger association of the driver with the infrastructure which is provided by the portal. The operator of the portal can also provide its own lead transportation vehicles 2 for sections of a route which is particularly in demand.

### LIST OF REFERENCE NUMBERS

1 Following transportation vehicle
2 Lead transportation vehicle
3 Switching device
4 Arrow; direction of travel
5 Data-transmitting connection (switching device-lead transportation vehicle)
6 Data-transmitting connection (switching device-following transportation vehicle)
7 Data-transmitting connection (following transportation vehicle-lead transportation vehicle)
8 Road network; road
9 Further transportation vehicle
10 Control unit (following transportation vehicle)
11 Computing unit
12 Touch screen
13 Output unit
14 Input unit
15a; 15b; 15c Driver assistance systems
16a; 16b Following transportation vehicle sensors
17 Navigation system
19 Communication unit (following transportation vehicle)
20 Control unit (lead transportation vehicle)
21 Tracking unit
29 Communication unit (lead transportation vehicle)
30 Control unit (switching device)
31 Acquisition unit
32 Offer unit
33 Payment module
39 Communication unit (switching device)

1. A method for providing at least partially automatic guidance of a following transportation vehicle, the method comprising:
acquiring availability data of at least one lead transportation vehicle;
acquiring request data of the following transportation vehicle;
generating offer data about the lead transportation vehicle based on the availability data and the request date and transmitting the offer data about the lead transportation vehicle to the following transportation vehicle;
generating and outputting an offer output based on the offer data;
acquiring a user input and generating acceptance data based on of the user input;
generating tracking data and transmitting the tracking data to the following transportation vehicle; and
guiding the following transportation vehicle at least partially automatically behind the lead transportation vehicle based on the tracking data.

2. The method of claim 1, wherein the availability data of the at least one lead transportation vehicle comprise a current position, a planned route and/or a maximum number of permitted following transportation vehicles.

3. The method of claim 1, wherein the request data of the following transportation vehicle comprise a current position and/or a planned route.

4. The method of claim 1, wherein the request data are generated automatically during a route planning operation of a navigation system.

5. The method of claim 1, wherein the request data are generated based on a further user input.

6. The method of claim 1, wherein a graphic representation of a route with information about the at least one lead transportation vehicle is displayed when the offer output is output.

7. The method of claim 1, wherein a tracking confirmation of the lead transportation vehicle is acquired and transmitted to the following transportation vehicle.

8. The method of claim 1, wherein the tracking data comprise information for guiding the following transportation vehicle to a target position relative to the lead transportation vehicle.

9. The method of claim 1, wherein data on the surroundings are acquired by following transportation vehicle sensors during the automatic guidance of the following transportation vehicle and plausibility of the tracking data is checked based on the acquired data on the surroundings.

10. The method of claim 1, wherein a payment module determines a tracking price and an account which is assigned to the following transportation vehicle is debited as a function of the determined tracking price.

11. The method of claim 1, wherein the availability data are acquired and stored by a switching device, and the offer data are generated by the switching device.

12. The method of claim 11, wherein the request data are generated and transmitted automatically in response to registration of the following transportation vehicle being registered for the switching device.

13. The method of claim 11, wherein the acceptance data are transmitted from the following transportation vehicle to the switching device, and the switching device establishes a data-transmitting connection of the following transportation vehicle to the lead transportation vehicle.

14. A system for providing at least partially automatic guidance of a following transportation vehicle, the system comprising:
an acquisition unit for acquiring availability data of at least one lead transportation vehicle and request data of the following transportation vehicle;
an offer unit for generating offer data about the lead transportation vehicle based on the availability data and the request data and transmitting offer data about the lead transportation vehicle to the following transportation vehicle;
a computing unit for generating offer output based on of the offer data;
an output unit for outputting the offer output;
an input unit for acquiring a user input, wherein acceptance data is generated based on the user input;
a tracking unit for generating tracking data and transmitting tracking data to the following transportation vehicle; and
a control unit for guiding the following transportation vehicle at least partially automatically behind the lead transportation vehicle based on the tracking data.

15. The system of claim 14, wherein a planned route of the following transportation vehicle is generated by a navigation system, and the request data is generated automatically based on the planned route.

16. The system of claim 14, wherein the availability data of the at least one lead transportation vehicle comprise a current position, a planned route and/or a maximum number of permitted following transportation vehicles.

17. The system of claim 14, wherein the request data of the following transportation vehicle comprise a current position and/or a planned route.

18. The system of claim 14, wherein the request data are generated automatically during a route planning operation of a navigation system.

19. The system of claim 14, wherein the request data are generated based on a further user input.

20. The system of claim 14, wherein a graphic representation of a route with information about the at least one lead transportation vehicle is displayed when the offer output is output.

21. The system of claim 14, wherein a tracking confirmation of the lead transportation vehicle is acquired and transmitted to the following transportation vehicle.

22. The system of claim 14, wherein the tracking data comprise information for guiding the following transportation vehicle to a target position relative to the lead transportation vehicle.

23. The system of claim 14, wherein data on the surroundings are acquired by following transportation vehicle sensors during the automatic guidance of the following transportation vehicle and plausibility of the tracking data is checked based on the acquired data on the surroundings.

24. The system of claim 14, wherein a payment module determines a tracking price and an account which is assigned to the following transportation vehicle is debited as a function of the determined tracking price.

25. The system of claim 14, wherein the availability data are acquired and stored by a switching device, and the offer data are generated by the switching device.

26. The system of claim 25, wherein the request data are generated and transmitted automatically in response to registration of the following transportation vehicle being registered for the switching device.

27. The system of claim 25, wherein the acceptance data are transmitted from the following transportation vehicle to the switching device, and the switching device establishes a data-transmitting connection of the following transportation vehicle to the lead transportation vehicle.
